(19) United States
(12) Patent Application Publication
(10) Pub. No.: US 2014/0309391 A1
(43) Pub. Date: Oct. 16, 2014

(54) Acryl-based Copolymer Having Superior Heat Resistance and a Method for Manufacturing the Same

(71) Applicant: Cheil Industries Inc., Gumi-si (KR)

(72) Inventors: In Sik Jeon, Uiwang-si (KR); Beom Jun Joo, Uiwang-si (KR); Im Hyuck Bae, Uiwang-si (KR)

(73) Assignee: Cheil Industries Inc., Gum-si, Gyeongsangbuk-do (KR)

(21) Appl. No.: 14/362,188

(22) PCT Filed: Nov. 8, 2012
(86) PCT No.: PCT/KR2012/009399

§ 371 Date: Jun. 2, 2014

(30) Foreign Application Priority Data
Dec. 6, 2011 (KR) 10-2011-0129443
Oct. 26, 2012 (KR) 10-2012-0119686

(51) Int. Cl. C08F 220/56; C08F 220/14

(52) U.S. Cl. CPC C08F 220/56; C08F 220/14
USPC 526/204; 526/307.7; 526/219.6; 526/220; 526/89

(57) ABSTRACT

The acrylic copolymer according to the present invention has a specific repeating unit and includes, in a chain, a methacrylate unit, a glutaric anhydride unit, or a mixture thereof in the amount of 0 to 1 ppm.

### FIELD OF THE INVENTION

The present invention relates to an acryl-based copolymer. More specifically, the present invention relates to a method for manufacturing an acryl-based copolymer having superior heat resistance by containing glutarimide in a chain.

### BACKGROUND OF THE INVENTION

Recently, requirements for a resin having excellent transparency for replacing glass materials has highly stood out in company with requirements for lightening display materials used for various kinds of electronic devices such as laptops, mobile phones, and mobile information terminals. Transparent plastic has been spotlighted, as a core material for controlling optical techniques, in fields for electronic materials and advanced materials, and is an environmentally friendly material since it has low specific gravity compared to inorganic glass so it can be lighten to make it possible to efficiently use energy. Polymethylmethacrylate, known as a representative transparent resin, has excellent moldability and processability, is strong against cracking, cheap, and has been applied to electronic equipment materials such as liquid crystal displays, optical disks, lenses, and light guide plates.

The transparent resin requires heat resistance in addition to transparency in accordance with that the usage of the transparent resin is expanded to head lamp covers for vehicles, members for liquid displays, LED lights, and the likes. Polymethylmethacrylate has excellent transparency and comparatively reasonable price but has low heat resistance, and thus the above-mentioned usage thereof is partially limited. Polycarbonate, known as a resin having better heat resistance than that of the polymethylmethacrylate, has low transparency, weather resistance, and scratch resistance compared to the polymethylmethacrylate, and thus study on improving those physical properties is required.

As a method for improving heat resistance of polymethylmethacrylate, a method for copolymerizing methyl methacrylate and alkyl/aryl maleimide has been already put in practical use. However, since the method uses alkyl/aryl maleimide, which is an expensive monomer, the copolymer has high price, and transparency of a manufactured copolymer are degraded, and thus there is a limit on application as a transparent resin. Further, drastically high difference on reactivities of two monomers in use can cause optical loss due to non-uniformity of compositions in the copolymer in accordance with conversion rate.

Meanwhile, U.S. Pat. No. 4,246,374, U.S. Pat. No. 4,727,117, U.S. Pat. No. 5,004,777, U.S. Pat. No. 4,954,574 and U.S. Pat. No. 5,264,483 suggest a method for obtaining an imide-based resin by imidizing a methyl ester group in a methyl methacrylate by treating polymethylmethacrylate or a methyl methacrylate-styrene copolymer with primary amine. Those patents disclose a method for introducing a glutarimide group in a cyclic imide form into a chain of an acryl-based resin by making polymethylmethacrylate (PMMA) react with gaseous primary amine at a high temperature of 300° C. or more. In this case, that high temperature, which decomposes an ester group by primary amine, leads to generate a methacrylic acid group and a glutaric acid anhydride group in a chain as byproducts. When those acrylic acid group and glutaric acid anhydride group are contained in the resin, it can hinder the resin from mixing with other thermoplastic polymers and reduce fluidity, and thus degrade processability and reduce weather resistance due to increase of hygroscopic properties of resin itself. Further, it is reported that polymers manufactured by the above-mentioned method are transparent but has yellow colors. Furthermore, the above-mentioned manufacturing method has a disadvantage that the content of a glutarimide group in a chain of a final product cannot be variously controlled according to the desire of a user due to the limit of the manufacturing method.

In order to overcome the above-mentioned problem, the present inventor has developed an acryl-based copolymer which includes a glutarimide group in a chain and does not include a methacrylic acid unit, a glutaric acid anhydride unit, or a mixture thereof; and a method for manufacturing the same.

### DETAILED DESCRIPTION OF THE INVENTION

### Technical Subject

The objective of the present invention is to provide an acryl-based copolymer having superior transparency.

Another objective of the present invention is to provide to an acryl-based copolymer having superior heat resistance.

Yet another objective of the present invention is to provide a method for manufacturing an acryl-based copolymer which can quantitatively variously adjust the content of a unit containing a glutarimide group in a chain of a final product.

Yet another objective of the present invention is to provide a method for manufacturing an acryl-based copolymer without limitation due to reaction temperature.

The above-mentioned and other objectives of the present invention can be achieved by the present invention described below.

### Technical Solution

An acryl-based copolymer according to the present invention is characterized by having a repeating unit represented by Chemical formula 1 below, and including a (meth)acrylic acid unit, a glutaric anhydride unit, or a mixture thereof in a chain in a range of 0 to 1 ppm.

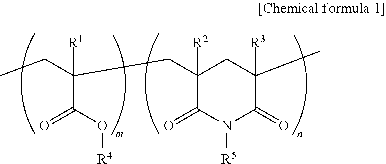

In the Chemical formula, each of R¹, R², and R³ is independently hydrogen or a methyl group; each of R⁴ and R⁵ is respectively a linear or branched C1-C12 alkyl group, a C1-C6 alkyl substituted or non-substituted C3-C12 cycloalkyl group, or a C1-C12 alkyl substituted or non-substituted C6-C30 aryl group; and m:n is a constant number ratio between 0:100 and 99:1, preferably a natural number ratio between 40:60 and 99:1.

The acryl-based copolymer of Chemical formula 1 according to the present invention is prepared by polymerizing alkyl or aryl methacrylate and alkyl or aryl (meth)acrylamide in an organic solvent to generate an alkyl or aryl (meth)acrylate-alkyl or aryl (meth)acrylamide copolymer (“copolymer generation step”), and performing cyclization by adding a cyclization catalyst to alkyl or aryl (meth)acrylate-alkyl or aryl (meth)acrylamide copolymer (“cyclization step”).

The copolymer generation step and the cyclization step are performed at a temperature between 20 and 200° C.

In the copolymer generation step, alkyl or aryl (meth)acrylate is used in 50 to 99 weight %, and alkyl or aryl (meth)acrylamide is used in 1 to 50 weight %.

In the copolymer generation step, organic peroxide, an azo-based polymerization initiator, or a mixture thereof is used in 0.1 to 1.0 parts by weight with respect to 100 parts by weight of a monomer mixture as a radical polymerization initiator.

In the copolymer generation step, amides, ethers, aromatics, or a mixture thereof is used in 10 to 500 parts by weight with respect to 100 parts by weight of a monomer mixture as an organic solvent.

In the cyclization step, alkoxide, hydroxide, or (bi)carbonate of first group or second group alkaline metal; tertiary amine-based compound; or a mixture thereof is used 0.01 to 10 parts by weight with respect to 100 parts by weight of a monomer mixture as a cyclization catalyst.

The copolymer generation step and the cyclization step are simultaneously performed.

Referring to drawings attached below, the specific description of the present invention is expressed as below.

### Beneficial Effect of the Invention

A method for manufacturing an acryl-based copolymer according to the present invention has an effect which provides an acryl-based copolymer having superior transparency and heat resistance, which can quantitatively variously adjust the content of a unit containing a glutarimide group in the chain of a final product and does not have a limit due to reaction temperature.

### BRIEF DESCRIPTION OF DRAWINGS

FIG. 1 is 1H-NMR spectrum of an acryl-based copolymer according to the embodiment 1 of the present invention.

FIG. 2 is a graph displaying change in weight according to time/temperature of an acryl-based copolymer in the embodiment 11 and the comparative embodiment 2.

### OPTICAL EMBODIMENT OF THE PRESENT INVENTION

The present invention relates to an acryl-based copolymer and relates to an acryl-based copolymer having superior heat resistance by containing glutarimide in a chain and a method for manufacturing the same. Specific description will be explained below in detail.

Acryl-Based Copolymer

An acryl-based copolymer according to the present invention is characterized by having a repeating unit represented by Chemical formula 1 below and containing almost no or a minute amount of a (meth)acrylic acid unit, a glutaric acid anhydride unit, or a mixture thereof.

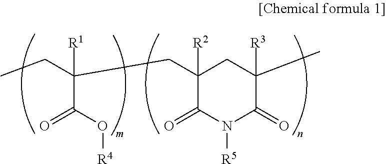

In Chemical formula 1, each of R¹, R² and R³ is independently hydrogen or a methyl group; each of R⁴ and R⁵ is independently a linear or branched C1-C12 alkyl group, a C1-C6 alkyl substituted or non-substituted C3-C12 cycloalkyl group, or a C1-C12 alkyl substituted or non-substituted C6-C30 aryl group; and m:n is a constant number ratio of 0:100 to 99:1.

As described above, an existing acryl-based resin containing glutarimide group contains a (meth)acrylic acid unit, a glutaric acid anhydride unit, or a mixture thereof in a chain as byproducts from a manufacturing process. Those byproducts hinder the acryl-based resin from mixing with other thermoplastic polymers, reduces fluidity to reduce processability, increases hygroscopicity of resin itself to reduce weather resistance, and causes a problem that yellows the resin.

However, the acryl-based copolymer of the present invention overcomes the above-mentioned problems by including a glutarimide group in the chain and hardly including or including a minute amount of a (meth)acrylic acid unit and/or a glutaric acid anhydride unit.

The acryl-based copolymer of the present invention can include the (meth)acrylic acid unit, the glutaric acid anhydride unit, or a mixture thereof in the range of 0 to 1 ppm, preferably 0 to 1 ppb, more preferably 0 to 1 ppt. This means the acryl-based copolymer of the present invention substantially does not include the (meth)acrylic acid unit, the glutaric acid anhydride unit, or the mixture thereof.

In Chemical formula 1, preferably each of R⁴ and R⁵ is independently a linear or branched C1-C12 alkyl group, a C1-C6 alkyl substituted or non-substituted C3-C12 cycloalkyl group, or a C1-C12 alkyl substituted or non-substituted C6-C30 aryl group.

The linear or branched C1-C12 alkyl group is a linear or branched alkyl group having 1 to 12 carbon numbers, and examples thereof are methyl, ethyl, normal propyl, isopropyl, normal butyl, isobutyl, tertiary butyl, normal penthyl, isopenthyl, neopenthyl, hexyl, heptyl, octyl, nonyl, decyl, undecyl, dodecyl, and the likes.

The C1-C6 alkyl substituted or non-substituted C3-C12 cycloalkyl group is a cycloalkyl group having 3 to 12 carbon numbers, which is substituted with one or more alkyl groups having 1 to 6 carbon numbers or non-substituted, and examples thereof are cyclopropyl, cyclobutyl, cyclopenthyl, cyclohexyl, cycloheptyl, cyclooctyl, cyclononyl, cyclodecyl, cycloundecyl, cyclododecyl, butyl cyclopropyl, methyl cyclopenthyl, dimethyl cyclohexyl, ethyl dimethylcycloheptyl, dimethyl cyclooctyl, and the likes.

The C1-C12 alkyl substituted or non-substituted C6-C30 aryl group is an aryl group having 6 to 30 carbon numbers, which is substituted with one or more alkyl groups having 1 to 12 carbon numbers or non-substituted, and examples thereof is penyl, benzyl, tolyl, xylyl, naphthyl, anthryl, biphenyl, and the likes.

In Chemical formula 1, m:n is a constant number ratio of 0:100 to 99:1, and preferably a natural number ratio of 40:60 to 99:1. Generally, the higher n, which is the number of units containing glutarimide groups, the better heat resistance of an acryl-based copolymer.

The acryl-based copolymer of the present invention has glass transition temperature between 120 and 160° C., wherein the glass transition temperature is measured in a temperature range of 30 to 200° C. and at temperature raising rate of 10° C./min using DSC Q100 of TA INSTRUMENTS Corp. whose pan type is A1 and gas is N₂.

The acryl-based copolymer of the present invention has pyrolysis temperature between 350 to 400° C., wherein the pyrolysis temperature measures a point where 5 weight % among the entire polymer starts to decompose in a temperature range of 30 to 700° C. and at temperature raising rate of 20° C./min using TGA/DSC 1 of METTLER TOLEDO Corp. whose pan type is ALU OXIDE CRUCIBLES and gas is N₂.

The acryl-based copolymer of the present invention has initial permeability of 90% or more measured at the wavelength of 550 nm using a UV/Vis spectroscopic meter and has initial yellow index between 0.1 and 1 measured using a Minolta 3600D CIE Lab color-difference meter.

Method for Manufacturing an Acryl-Based Copolymer

An acryl-based copolymer according to the present invention is manufactured by polymerizing alkyl or aryl (meth)acrylate and alkyl or aryl (meth)acrylamide to generate alkyl or aryl (meth)acrylate-alkyl or aryl (meth)acrylamide copolymer (“copolymer generation step”), and adding a cyclization catalyst into the alkyl or aryl (meth)acrylate-alkyl or aryl (meth)acrylamide copolymer to perform cyclization (“cyclization step”).

As described above, an existing method for manufacturing an acyl-based resin containing a glutarimide group faces a problem that a methacrylic acid group and a glutaric acid anhydride group are generated as byproducts since polymethylmethacrylate (PMMA) reacts with gaseous primary amine at a high temperature of 300° C. or more. However, a method for manufacturing an acryl-based copolymer of the present invention is performed at relatively low temperatures compared to the existing manufacturing method, and basically overcomes a problem that a chain contains the byproducts as above since the primary amine does not used as a reactant.

Further, an existing method for manufacturing an acryl-based resin containing a glutarimide group has a disadvantage that the content of a glutarimide group in the chain of a final product cannot be variously controlled according to the desire of a user due to the limit of the manufacturing method. However, the method for manufacturing the acryl-based copolymer of the present invention can quantitatively variously control the content of a unit containing a glutarimide group in the chain of the final product by controlling the content of alkyl or aryl (meth)acrylate and alkyl or aryl (meth)acrylamide as reactants, and thus acryl-based copolymer having various heat resistance can be manufactured easily in accordance with user's wish.

The existing method for manufacturing the acryl-based resin containing the glutarimide group performs a cyclization step at a relatively high temperature of 300° C. or more in order to provide gaseous primary amine. However, the method for manufacturing the acryl-based copolymer of the present invention has no limitation on reaction temperature since it is not necessary that the method for manufacturing the acryl-based copolymer of the present invention provides gaseous reactants.

Both the copolymer generation step and the cyclization step are performed at a temperature between 20 and 200° C. in the prevent invention. Performing the copolymer generation step and the cyclization step at such a low temperature saves manufacturing costs required for raising temperatures and prevents a problem that polymers decompose or are discolored at high temperatures.

Alkyl or aryl (meth)acrylate for the prevent invention is obtained by bonding a linear or branched C1-C12 alkyl group, a C1-C6 alkyl substituted or non-substituted C3-C12 cycloalkyl group, or a C1-C12 alkyl substituted or non-substituted C6-C30 aryl group to the oxygen atom of (meth)acrylate.

Alkyl or aryl (meth)acrylamide for the prevent invention is obtained by substituting a hydrogen atom bonded to the nitrogen atom of (meth)acrylamide with a linear or branched C1-C12 alkyl group, a C1-C6 alkyl substituted or non-substituted C3-C12 cycloalkyl group, or a C1-C12 alkyl substituted or non-substituted C6-C30 aryl group.

The Reaction formula 1 below shows the reaction mechanism of the acryl-based copolymer of the prevent invention.

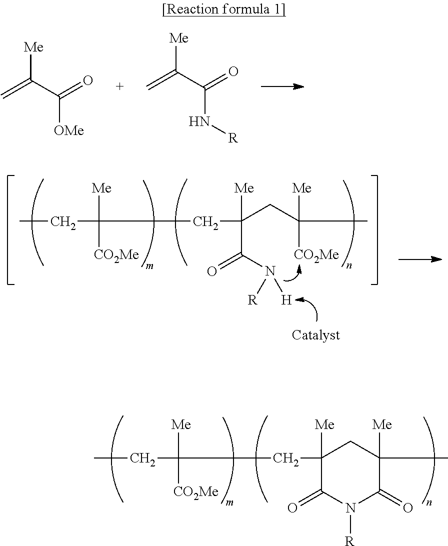

In Reaction formula 1, methyl methacrylate and alkyl or aryl methacrylamide are polymerized in an organic solvent to generate a methyl methacrylate-alkyl or aryl methacrylamide copolymer, and then adding a catalyst to the methyl methacrylate-alkyl or aryl methacrylamide copolymer to perform cyclization reaction and generate an acryl-based copolymer bonded with a methyl methacrylate unit and a unit containing a glutarimide group.

In the copolymer generation step, alkyl or aryl (meth)acrylate is used in 50 to 99 weight %, and alkyl or aryl (meth)acrylamide is used in 1 to 50 weight %.

In the copolymer generation step, organic peroxides, an azo-based polymerization initiator, or a mixture thereof can be used as a radical polymerization initiator. Preferably, 2,2′-azobis(isobutyronitrile)(AIBN) can be used. The polymerization initiator can be used in 0.1 to 1.0 parts by weight, preferably 0.2 to 0.5 parts by weight with respect to 100 parts by weight of a monomer mixture. When the content of the polymerization initiator is less than 0.1 parts by weight, polymerization speed can be drastically slow, and when the content of the polymer initiator is more than 1 part by weight, the molecular weight of the acryl-based copolymer can be lowered.

In the copolymer generation step, amides, ethers, aromatics, or a mixture thereof can be used as an organic solvent. An example of amides is dimethylformamide (DMF), dimethylacetamide (DMA), and the likes. An example of ethers is tetrahydrofuran (THF), dioxane, and the likes. An example of aromatics is toluene, xylene, and the likes. Preferably dimethylformamide and tetrahydrofuran can be used. The organic solvent can be used in 10 to 500 parts by weight, preferably 50 to 300 parts by weight, more preferably 50 to 100 parts by weight with respect to 100 parts by weight of a monomer mixture.

First or second family alkaline metal alkoxide, hydroxide, or (bi)carbonate; tertiary amine compound; or a mixture thereof can be used as a cyclization catalyst in the cyclization step. An example of the first family alkaline metal alkoxide is potassium tert-butoxide or sodium methoxide, an example of the first family alkaline metal hydroxide is potassium hydroxide (KOH), an example of the first family alkaline metal carbonate is potassium carbonate (K₂CO₃), and an example of the tertiary amine compound is 1,4-diazabicyclo[2.2.2]octane (DABCO). The cyclization catalyst can be used in 0.01 to 10 parts by weight, preferably 0.1 to 5 parts by weight, and more preferably 0.5 to 2 parts by weight with respect to 100 parts by weight of the monomer mixture.

When first or second family alkaline metal alkoxide, hydroxide, or (bi)carbonate is used as the cyclization catalyst, a step for removing metallic ions can be further included. For example, the metallic ions can be removed using a cation exchanging resin.

In the present invention, the copolymer generation step and the cyclization step are simultaneously performed. The copolymer generation step and the cyclization step can also be performed in a sequential manner. However, when the steps are simultaneously performed, an acryl-based copolymer having the same quality as that of an acryl-based copolymer manufactured by the sequential steps is obtained.

When imides are used as the organic solvent, tertiary amine compound can be used as the cyclization catalyst, and when ethers are used as the organic solvent, first family alkaline metal alkoxide can be used as the cyclization catalyst.

The acryl-based copolymer according to the present invention has superior transparency and heat resistance, and thus it can be variously applied to fields requiring the transparency, the heat resistance, or both of them. Examples of the fields are an image field such as a photographing lens, a finder, a filter, a prism, and a Fresnel lens for a camera or a projector; an optical disk such as a CD player, a DVD player, and an MD player; lens filed such as pick up lens; an optical recording field for an optical disk such as a CD player, a DVD player, an MD player; an information device field such as a light guiding plate for liquid crystal, a film for liquid crystal display like a polarizer protective film or a phase difference film, and a surface protective film; an optical communication field such as an optical fiber, an optical switch, and an optical connector; a vehicle filed such as a vehicle headlight or a tail lamp lens, an inner lens, a gauge cover, and a sunroof; a glasses or a contact lens; a medical device such as a lens for an endoscope and a medical appliance requiring sterilization; a construction and building material such as sizing for a building material; and a home appliance such as a microwave oven.

Thermoplastic Resin Composition

The acryl-based copolymer according to the present invention can be used by being mixed with other thermoplastic resins by the purpose thereof, and a thermoplastic resin composition includes an acryl-based copolymer.

The thermoplastic resin composition can include one or more additives among a flame retardant, a dropping preventive agent, an impact reinforcing agent, an anti-oxidant agent, a plasticizer, a thermostabilizer, an optical stabilizer, a compatibilizing agent, a pigment, a dye, an inorganic additive, an antimicrobial, an antistatic agent, a nucleic agent, a coupling agent, a filler, a surfactant, a lubricant, and a release agent.

Further, a pellet or a molded article can be manufactured based a known method using the thermoplastic resin composition. For example, components of the present invention and other additives are simultaneously mixed, and then molten-extruded in an extruder to form a pellet form. A plastic injection and compression molded article can be manufactured using the pellet.

The present invention will be specified by embodiments below, but the embodiments below are used to exemplify the present invention and do not limit a range of protection.

### EMBODIMENT OF THE PRESENT INVENTION

### Embodiments

### Embodiments 1 to 5

As the table 1 below, 100 g of methyl methacrylate, 10-50 g of methyl methacrylamide, 0.25 to 0.8 parts by weight of 2,3′-azobis(isobutyronitrile), and 0.5 to 0.8 parts by weight of DABCO are dissolved in 100 g of dimethylformamide (DMF), and then the dissolved product is stirred in a sealed container at 160° C. for 3 hours. The solution is cooled to room temperature, and then precipitated in an excessive amount of methanol to obtain a white solid acryl-based copolymer.

### Embodiment 6

As the table 1 below, an acryl-based copolymer is obtained by the same method as the embodiments 1 to 5 except for using 30 g of isopropyl methacrylamide instead of methyl methacrylamide and 0.5 parts by weight of potassium carbonate (K₂CO₃) instead of DABCO.

### Embodiments 7 to 11

As the table 1 below, 100 g of methyl methacrylate, 10 to 100 g of methyl methacrylamide, and 0.3 parts by weight of 2,2′-azobis(isobutyronitrile) are dissolved in 100 g of tetrahydrofuran (THF), and then the dissolved product is stirred at 66° C. for 20 hours. After copolymerization, 0.5 parts by weight of potassium tert-butoxide (t-BuOK) in a state of being molten in a minute amount of alcohol is introduced and undergoes cyclization for 3 hours. The solution is cooled to room temperature, and then neutralized with acetic acid. Metallic ions are removed from the resultant product using a cation exchanging resin. The manufactured polymer is precipitated in an excessive amount of methanol to obtain a white solid acryl-based copolymer.

### Comparative Embodiments 1 to 2

As the table 1 below, 100 g of methyl methacrylate and 0.25 to 0.8 parts by weight of 2,2′-azobis(isobutyronitrile) are dissolved in 100 g of toluene, and the dissolved product is stirred at 70° C. for 15 hours. The solution is cooled to room temperature, and then precipitated in hexane to obtain a white solid polymethylmethacrylate (PMMA).

### Comparative Embodiment 3

A polymer is manufactured by supplying polymethylmethacrylate (PMMA) into a biaxial extruder at the rate of 70 g/min and supplying monomethyl amine into the biaxial extruder at the rate of 38 cc/min under a temperature of 280 to 300° C. and a pressure of 5.51 MPa. The biaxial extruder of 50.8 mm from a welding engineer Corp. equipped with a part for mixing methyl amine and a part for devolatilizing an excessive amount of amine and a reaction byproduct is used as the biaxial extruder. The polymer manufactured by the above-mentioned method is a polymer containing most (76 weight %) of an N-methyl dimethyl glutarimide unit, nitrogen in the content of 6.0%, and has glass transition temperature of 150° C. and acid and anhydride in 5% of the entire content.

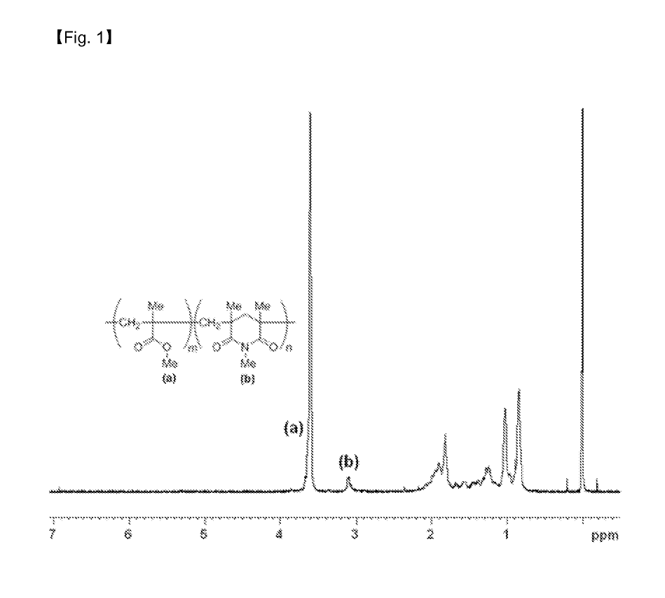

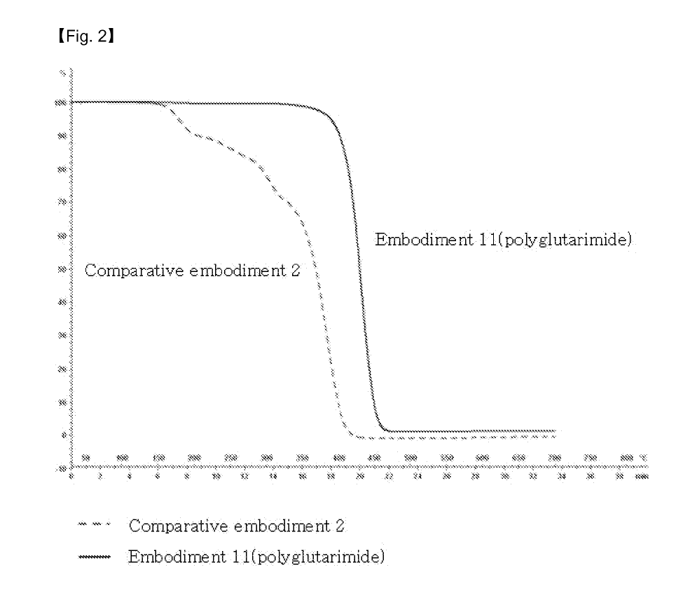

Structures and physical properties of acryl-based copolymers manufactured by the embodiments and the comparative embodiments are measured by methods below, and the result thereof is showed on the table 1 and FIGS. 1 and 2.

(1) Structure analysis (1H-NMR): 300 MHz NMR product is used from Bruker Corp., and CDCl₃ is used as a solvent.

(2) Weight average molecular weight and molecular weight distribution (GPC): 0.01 g to 0.015 g of a sample is dissolved in about 10 mL of THF, and the dissolved sample is filtered using 0.45 μm syringe filter, and the filtered sample is injected into a column. Specific measurement systems and measurement conditions are as below.

| | |
|---|---|
| System | Waters 515 HPLC pump |
| | Waters 2414 RI detector |
| | waters 717 plus auto sampler |
| Column | Shodex LF-804 2ea (8.0 I.D. × 300 mm) |
| Flow(ml/min) | 1.0 |
| Pressure(psi) | 645 |
| Solvent | THF |
| Injection volume(μl) | 200 |
| Oven temp. | 40° C. |

(3) Glass transition temperature (DSC): DSC Q100 from TA INSTRUMENTS Corp. whose pan type is A1 and gas is N₂ is used, and the glass transition temperature is measured at a temperature range of 30 to 200° C. and a temperature raising speed of 10° C./min.

(4) Pyrolysis temperature (TGA): TGA/DSC 1 from METTLER TOLEDO Corp. whose pan type is ALU OXIDE CRUCIBLES and gas is N₂ is used, and a point where 5 weight % of the entire weight of the polymer decomposes is measured at a temperature range of 30 to 700° C. and a temperature raising speed of 20° C./min.

(5) Transmittancy: Transmittancy is measured using Nippon Denshoku Industries Co. LTD, NHD-5000 based on an ASTM D1003 method at the wavelength of 550 nm after a sample having a thickness of 3 mm is manufactured.

(7) Yellow index (YI): Yellow index is measured using a Minolta 3600 CIE Lab color-difference meter based on an ASTM D1925 method after a sample having a thickness of 3 mm is manufactured.

(8) Measurement method of acid or anhydride content: content is measured after polymer samples of embodiments and comparative embodiments are dissolved using a DMSO solvent and titrated using a 0.1 N KOH solution.

TABLE 1

| | | Embodiments | | | | | | |
|---|---|---|---|---|---|---|---|---|
| | | 1 | 2 | 3 | 4 | 5 | 6 | 7 |
| Methyl methacrylate | | 90.9 | 90.9 | 83.3 | 76.9 | 66.7 | 76.9 | 90.9 |
| (weight %) | | | | | | | | |
| Methyl | | 9.1 | 9.1 | 16.7 | 23.1 | 33.3 | — | 9.1 |
| methacrylamide | | | | | | | | |
| (weight %) | | | | | | | | |
| Isopropyl | | — | — | — | — | — | 23.1 | — |
| methacrylamide | | | | | | | | |
| (weight) | | | | | | | | |
| Polymerization | | 0.80 | 0.25 | 0.25 | 0.25 | 0.25 | 0.25 | 0.30 |
| initiator | | | | | | | | |
| (parts by weight) | | | | | | | | |
| Organic | DMF | 90.9 | 90.9 | 83.3 | 76.9 | 66.7 | 76.9 | — |
| solvent | THF | — | — | — | — | — | — | 90.9 |
| (parts by | Toluene | — | — | — | — | — | — | — |
| weight) | | | | | | | | |
| Cyclization | DABCO | 0.8 | 0.5 | 0.5 | 0.5 | 0.5 | — | — |
| catalyst | K2CO3 | — | — | — | — | — | 0.5 | — |
| (parts by | t-BuOK | — | — | — | — | — | — | 0.5 |
| weight) | | | | | | | | |

| | | | | | | | |
|---|---|---|---|---|---|---|---|
| Weight average | 27,000 | 144,000 | 77,000 | 29,000 | 80,000 | 129,000 | 51,000 |
| molecular weight (Mw) | | | | | | | |
| Molecular weight | 1.5 | 3.4 | 2.4 | 1.9 | 2.3 | 2.3 | 2.1 |
| distribution (PDI) | | | | | | | |
| Glass transition | 123 | 125 | 130 | 133 | 134 | 129 | 126 |
| temperature (T_{g}) | | | | | | | |
| Pyrolysis | 352 | 356 | 368 | 372 | 384 | 357 | 356 |
| temperature(T_{d,5%}) | | | | | | | |
| Transmittancy (3 mm, | 92 | 92 | 92 | 91 | 91 | 91 | 92 |
| ASTM D1003) | | | | | | | |
| Yellow index (3 mm, | 0.4 | 0.4 | 0.4 | 0.5 | 0.5 | 0.5 | 0.4 |
| ASTM D1925) | | | | | | | |
| Acid or anhydride | 0 | 0 | 0 | 0 | 0 | 0 | 0 |
| content (meq./g) | | | | | | | |

| | | Embodiments | | | | Comparative embodiments | | |
|---|---|---|---|---|---|---|---|---|
| | | 8 | 9 | 10 | 11 | 1 | 2 | 3 |
| Methyl methacrylate | | 83.3 | 76.9 | 66.7 | 50.0 | 100 | 100 | |
| (weight %) | | | | | | | | |
| Methyl | | 16.7 | 23.1 | 33.3 | 50.0 | — | — | |
| methacrylamide | | | | | | | | |
| (weight %) | | | | | | | | |
| Isopropyl | | — | — | — | — | — | — | |
| methacrylamide | | | | | | | | |
| (weight) | | | | | | | | |
| Polymerization | | 0.30 | 0.30 | 0.30 | 0.30 | 0.25 | 0.80 | |
| initiator | | | | | | | | |
| (parts by weight) | | | | | | | | |
| Organic | DMF | — | — | — | — | — | — | |
| solvent | THF | 83.3 | 76.9 | 66.7 | 50 | — | — | |
| (parts by | Toluene | — | — | — | — | 100 | 100 | |
| weight) | | | | | | | | |
| Cyclization | DABCO | — | — | — | — | — | — | |
| catalyst | K2CO3 | — | — | — | — | — | — | |
| (parts by | t-BuOK | 0.5 | 0.5 | 0.5 | 0.5 | — | — | |
| weight) | | | | | | | | |

| | | | | | | | |
|---|---|---|---|---|---|---|---|
| Weight average | 53,000 | 56,000 | 66,000 | 79,000 | 125,000 | 33,000 | 148,000 |
| molecular weight (Mw) | | | | | | | |
| Molecular weight | 2.2 | 2.1 | 2.2 | 2.2 | 2.0 | 1.7 | 2.3 |
| distribution (PDI) | | | | | | | |
| Glass transition | 126 | 133 | 139 | 159 | 105 | 102 | 150 |
| temperature (T_{g}) | | | | | | | |
| Pyrolysis | 375 | 382 | 389 | 397 | 181 | 178 | 388 |
| temperature(T_{d,5%}) | | | | | | | |
| Transmittancy (3 mm, | 92 | 91 | 91 | 91 | 92 | 92 | 90 |
| ASTM D1003) | | | | | | | |
| Yellow index (3 mm, | 0.4 | 0.5 | 0.5 | 0.5 | 0.4 | 0.4 | 3.4 |
| ASTM D1925) | | | | | | | |
| Acid or anhydride | 0 | 0 | 0 | 0 | 0 | 0 | 0.5 |
| content (meq./g) | | | | | | | |

The FIG. 1 below is a 1H-NMR spectrum of an acryl-based copolymer according to the embodiment 1 of the present invention. It is known that there is a peak at 3.1 ppm by a glutarimide group on the FIG. 1.

As the table 1 above, acryl-based copolymers according to the embodiments 1 to 5 have drastically superior heat resistance by including a glutarimide group through cyclization compared to conventional polymethylmethacrylate (Comparative embodiments 1 to 2).

Further, an acryl-based copolymer according to the embodiment 6 has slightly reduced heat resistance and still superior heat resistance using isopropyl methacrylamide instead of methyl methacrylamide and using potassium carbonate instead of DABCO compared to acryl-based copolymers of the embodiments 1 to 5.

Further, acryl-based copolymers of embodiments 7 to 11 have more superior heat resistance than those of acryl-based copolymers of embodiments 1 to 5 using THF instead of DMF and using first family alkaline metal alkoxide instead of DABCO.

The FIG. 2 below is a graph showing change in weight in accordance with time/temperature rise of acryl-based copolymers of the embodiment 11 and the comparative embodiment 2. As the FIG. 2, the acryl-based copolymer of the embodiment 11 starts to reduce its weight at a temperature above 350° C., and the acryl-based copolymer of the comparative embodiment 2 starts to reduce its weight at a temperature of 150° C.

Further, it is known that the embodiments 1, 2, and 7 have drastically superior heat resistance compared to conventional polymethylmethacrylate (Comparative embodiments 1 and 2) although they use methyl methacrylamide.

The comparative embodiment 3 causes deformation in a reactant by injecting gas at high temperatures, and results in byproducts in acid and anhydride forms and performs reaction at high temperatures, accordingly reduce optical properties.

Simple modification and changes in the present invention can be easily implemented by person who has conventional knowledge in this field, and those modification and changes can be included in the range of the present invention.

1. Acryl-based copolymer having a repeating unit represented by Chemical formula 1 and including 0 to 1 ppm of a (meth)acrylic acid unit, a glutaric anhydride unit, or a mixture thereof in a chain: 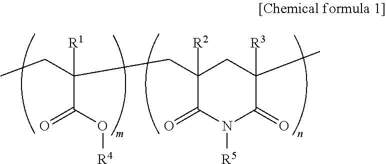
wherein, in Chemical formula 1, each of R¹, R², and R³ is independently hydrogen or a methyl group; each of R⁴ and R⁵ is independently a linear or branched C1-C12 alkyl group, a C1-C6 alkyl substituted or non-substituted C3-C12 cycloalkyl group, or a C1-C12 alkyl substituted or non-substituted C6-C30 aryl group; and m:n is an integer number ratio of 0:100 to 99:1.

2. The acryl-based copolymer according to claim 1, wherein m:n is an integer number ratio of 40:60 to 99:1.

3. The acryl-based copolymer according to claim 1, having a glass transition temperature of 120 to 160° C. measured at a temperature range of 30 to 200° C. and a temperature raise rate of 10° C./min using a DSC Q100 of TA INSTRUMENTS Corp. whose pan type is A1 and gas is N₂, and a pyrolysis temperature of 350 to 400° C. measured at a temperature range of 30 to 700° C. and a temperature raise rate of 20° C./min using a TGA/DSC 1 of METTLER TOLEDO Corp. whose pan type is ALU OXIDE CRUCIBLES and gas is N₂, wherein the pyrolysis temperature measures a point where 5 weight % the weight of the entire polymer decomposes.

4. The acryl-based copolymer according to claim 1, having a transmittance of 90% or more measured at a wavelength of 550 nm using an UV/Vis spectroscopic meter, and a yellow index of 0.1 to 1 measured using a Minolta 3600D CIE Lab color-difference meter.

5. A method for manufacturing an acryl-based copolymer having a repeating unit represented by Chemical formula 1 comprising the steps of:
polymerizing alkyl or aryl (meth)acrylate and alkyl or aryl (meth)acrylamide in an organic solvent to generate an alkyl or aryl (meth)acrylate-alkyl or aryl (meth)acrylamide copolymer (“copolymer generation step”); and
adding a cyclization catalyst into the alkyl or aryl (meth)acrylate-alkyl or aryl (meth)acrylamide copolymer to perform cyclization (“cyclization step”): 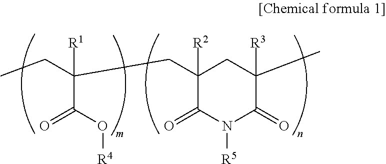
wherein in Chemical formula 1, each of R¹, R², and R³ is independently hydrogen or a methyl group; each of R⁴ and R⁵ is independently a linear or branched C1 to C12 alkyl group, a C1 to C6 alkyl substituted or non-substituted C3 to C12 cycloalkyl group, or a C1 to C12 alkyl substituted or non-substituted C6 to C30 aryl group; and m:n is an integer number ratio of 0:100 to 99:1.

6. The method for manufacturing the acryl-based copolymer according to claim 5, wherein the copolymer generation step, the cyclization step, or both steps are performed at 20 to 200° C.

7. The method for manufacturing the acryl-based copolymer according to claim 5, wherein in the copolymer generation step, the alkyl or aryl (meth)acrylate is used in an amount of 50 to 99 weight %, and the alkyl or aryl (meth)acrylamide is used in an amount of 1 to 50 weight %.

8. The method for manufacturing the acryl-based copolymer according to claim 5, wherein in the copolymer generation step, a radical polymerization initiator including an organic peroxide, an azo-based polymerization initiator, or a mixture thereof is used in an amount of 0.1 to 1.0 parts by weight with respect to 100 parts by weight of a monomer mixture.

9. The method for manufacturing the acryl-based copolymer according to claim 5, wherein the organic solvent includes an amide, ether, aromatic, or a mixture thereof and is used in an amount of 10 to 500 parts by weight with respect to 100 parts by weight of a monomer mixture.

10. The method for manufacturing the acryl-based copolymer according to claim 5, wherein the cyclization catalyst includes a Group 1 or Group 2 metal alkoxide, hydroxide, or (bi)carbonate; tertiary amine-based compound; or a mixture thereof and is used in an amount of 0.01 to 10 parts by weight with respect to 100 parts by weight of a monomer mixture.

11. The method for manufacturing the acryl-based copolymer according to claim 5, wherein the copolymer generation step and the cyclization step are simultaneously performed.
